(19) United States
(12) Patent Application Publication
(10) Pub. No.: US 2014/0293516 A1
(43) Pub. Date: Oct. 2, 2014

(54) BUSWAY WITH INTEGRALLY FUSIBLE POWER FEEDS

(71) Applicant: UNIVERSAL ELECTRIC CORPORATION, Canonsburg, PA (US)

(72) Inventors: MARK A. SWIFT, BUTLER, PA (US); JAY W. LEWIS, JR., BRIDGEVILLE, PA (US); JUSTIN E. ROSS, CANONSBURG, PA (US)

(73) Assignee: UNIVERSAL ELECTRIC CORPORATION, Canonsburg, PA (US)

(21) Appl. No.: 14/227,209

(22) Filed: Mar. 27, 2014

Related U.S. Application Data
(60) Provisional application No. 61/805,552, filed on Mar. 27, 2013.

(51) Int. Cl. H02B 1/20; H02B 1/04

(52) U.S. Cl. CPC H02B 1/20; H02B 1/04
USPC 361/624; 361/657; 248/49; 248/65

(57) ABSTRACT

A power feed assembly for an electrical busway includes a housing and a fuse support coupled to the housing. The fuse support includes a non-conductive support member having a number of first conductive members and a number of second conductive members coupled thereto. Each of the first members are structured to couple a line voltage conductor passing through an opening in the housing to the support member and each of the second members are structured to be in electrical communication with a respective busbar of a section of electrical busway coupled to the housing. The support member is structured to have a number of fuses coupled thereto such that each fuse forms a portion of an electrical pathway between a respective one of the number of first conductive members and a respective one of the number of second conductive members.

### CLAIM TO PRIORITY

This patent application claims the priority benefit under 35 U.S.C. §119(e) of U.S. Provisional Application No. 61/805,552 filed on Mar. 27, 2013, and entitled, “Busway with Integrally Fusible Power Feeds”, the contents of which are hereby incorporated herein by reference.

### FIELD OF THE INVENTION

The present invention generally relates to electrical busways, and more particularly, relates to solutions for providing a plug-in busway system with electrical fuse protection. The invention also relates to power feed assemblies for use in electrical busways as well as to fuse supports for use in such power feed assemblies.

### DESCRIPTION OF THE RELATED ART

It is common in factories, shops, offices and other buildings to install overhead electrical power distribution tracks for providing a convenient source of electricity for lights, machines and other electrical devices in the buildings. Electrical power distribution tracks are typically comprised of an elongated housing containing multiple electrically-isolated, conductive busbars. Track lighting and continuous plug-in busway are typical of this type of track system. Sections of the track can be joined together to form long runs for power distribution. Take-off devices are used to tap power from the track or busway to the load apparatus. The load may be anything from a lamp to a three phase electrical machine. Busway systems in larger facilities are powered from high capacity sources, which can deliver tremendous amounts of power during a fault condition. Care must be taken to design the system to withstand the effects of the available fault current. One common method is to use current limiting fuses in the source circuit. Such fuses are typically located in the electrical switchgear is typically located in a different part of the building from the busway closer in proximity to the electrical service entrance. Such fuses are built to open very quickly, thereby limiting the fault current delivered to the downstream equipment. A drawback to fuse protection is making provision for the physical mounting and cabling of the fuse assembly. This is costly, requires space, and requires engineering attention to design the fuse assembly into the switchgear equipment. As a result, fuses are not widely used for this purpose.

### SUMMARY

These needs and others are met by embodiments of the present invention which, as a first aspect, provide a fuse support for use in a power feed unit of an electrical busway system. The fuse support comprises: a support member formed from a non-conductive material; a number of fasteners coupled to the support member, each fastener formed from a conductive material and structured to couple a line voltage conductor to the support member; and a number of stab members coupled to and extending from the support member, each stab member formed from a conductive material and structured to engage a respective busbar of a section of busway. The support member is structured to have a number of fuses coupled thereto such that each fuse forms a portion of an electrical pathway between a respective one of the number of fasteners and a respective one of the number of stab members.

The number of fasteners may be disposed generally about a first end of the support member and the number of stab members may extend from a second end of the support member generally opposite the first end.

The support member may be structured to be coupled to the housing of a power feed assembly and the number of stab members may be structured to protrude from the housing when the support member is coupled to thereto.

The support member may comprise a first support member formed from a nonconductive material and a second support member formed from a nonconductive material coupled to the first support member, wherein the number of fasteners are coupled to the first support member and wherein the number of stab members are coupled to the second support member.

As another aspect of the present invention, a power feed assembly for use in an electrical busway system is provided. The power feed assembly comprises a housing defined in-part by a number of removable access panels coupled thereto. The housing comprises: a first opening defined therein, the first opening being structured to have a section of electrical busway coupled thereto and a second opening defined therein, the second opening being structured to receive a number of line voltage conductors therethrough. The power feed assembly further comprises a fuse support coupled to the housing. The fuse support comprises: a support member formed from a non-conductive material; a number of first conductive members coupled to the support member, each first conductive member being structured to couple a respective one of the line voltage conductors to the support member; and a number of second conductive members, each second conductive member being structured to be in electrical communication with a respective busbar of a section of busway coupled to the housing. The support member is structured to have a number of fuses coupled thereto such that each fuse forms a portion of an electrical pathway between a respective one of the number of first conductive members and a respective one of the number of second conductive members.

The number of second conductive members may comprise a number of stab members coupled to and extending from the support member; the support member may be coupled to the housing about the first opening; the number of stab members may protrude from the housing through the first opening; and each stab member of the number of stab members may be structured to directly engage a respective busbar of a section of busway coupled to the housing.

The number of first conductive members may be disposed generally about a first end of the support member and the number of stab members may extend from a second end of the support member generally opposite the first end.

The support member may comprise a first support member formed from a non-conductive material and a second support member formed from a non-conductive material coupled to the first support member; the number of first conductive members may be coupled to the first support member; and the number of second conductive members may be coupled to the second support member.

As yet another aspect of the present invention, an electrical busway power distribution system is provided. The system comprises: a section of electrical busway including a housing having a number of electrical busbars disposed therein and a power feed assembly. The power feed assembly comprises a housing defined in-part by a number of removable access panels coupled thereto. The housing comprises: a first opening defined therein, the first opening having a portion of the section of electrical busway coupled thereabout; and a second opening defined therein, the second opening being structured to receive a number of line voltage conductors therethrough. The power feed assembly further comprises a fuse support coupled to the housing. The fuse support comprises: a support member formed from a non-conductive material; a number of first conductive members coupled to the support member, each first conductive member being structured to couple a respective one of the line voltage conductors to the support member; and a number of second conductive members coupled to the support member and in electrical communication with a respective electrical busbar of the section of electrical busway. The support member is structured to have a number of fuses coupled thereto such that each fuse forms a portion of an electrical pathway between a respective one of the number of first conductive members and a respective one of the number of second conductive members.

The number of second conductive members may comprise a number of stab members coupled to and extending from the support member; the support member may be coupled to the housing at or about the first opening; the number of stab members may protrude from the housing through the first opening; and each stab member of the number of stab members may directly engage a respective one of the electrical busbars of the section of electrical busway.

The number of first conductive members may be disposed generally about a first end of the support member and the number of stab members may extend from a second end of the support member generally opposite the first end.

The support member may comprise a first support member formed from a non-conductive material and a second support member formed from a non-conductive material coupled to the first support member; the number of first conductive members may be coupled to the first support member; and the number of second conductive members may be coupled to the second support member.

### BRIEF DESCRIPTION OF THE DRAWINGS

FIG. 1 is an isometric view of a continuous busway system in accordance with an example embodiment of the present invention.

FIG. 2 is an isometric view of a portion of the continuous busway system of FIG. 1 showing the power feed assembly with an access panel removed to show internal details in accordance with an example embodiment of the present invention.

FIG. 3 is an isometric view of a power feed assembly in accordance with another example embodiment of the present invention electrically coupled to a section of continuous busway extending therefrom.

FIG. 4 is an isometric view of the fuse support and busway of the embodiment of FIG. 3 shown exploded from each other to show details of the interconnecting portions.

FIG. 5 is an isometric view of the fuse support of FIGS. 3 and 4.

FIG. 6 is a partially exploded view of the power feed assembly of FIG. 4 showing the busway exploded from the power feed assembly

FIG. 7 is an exploded view of the fuse support of FIGS. 3-6.

### DETAILED DESCRIPTION OF EXEMPLARY EMBODIMENTS

As employed herein, the term “number” shall mean one or an integer greater than one and the singular form of “a”, “an”, and “the” include plural referents unless the context clearly indicates otherwise.

As employed herein, the phrase “directly engages” shall be used to refer to two elements that are in direct contact with each other (i.e., without an intermediary elements).

Busway systems and associated tap boxes and fittings are available in a wide range of fault current withstand ratings. High fault rated products can be directly connected to the source supply without current limiting protection. However, higher fault current rated devices are larger and more costly than lower fault current rated devices.

The present invention integrates a fuse support and fuses into the busway power feed assembly. Such an arrangement creates an efficient, easy to use and cost effective means to limit the fault current to the busway system and associated equipment. As a result, lower cost versions of busway and tap box overcurrent protection may be used. Just as important, the overall safety of the system is improved by reducing the available energy.

It is to be appreciated that embodiments of the present invention provide a number of benefits over the prior art. Reduced cost is one such benefit. Power feed assemblies must be used regardless of whether or not fuse protection is provided. Integrating fuses into a power feed assembly as described herein is an incremental cost increase, whereas separately mounted fuse cabinets have an order of magnitude cost increase. Separately mounted fuses have a need for separate cabinet or enclosure, additional wiring and physical mounting requirements. Fuses integrated into the power feed do not require any additional cabinet, wiring or mounting.

Improved convenience is another benefit. A single enclosure for feeding busway power as well as providing fault current protection is efficient, pre-engineered, and unobtrusive. This leads to more efficient design and selection of system components (such as busway and circuit breakers).

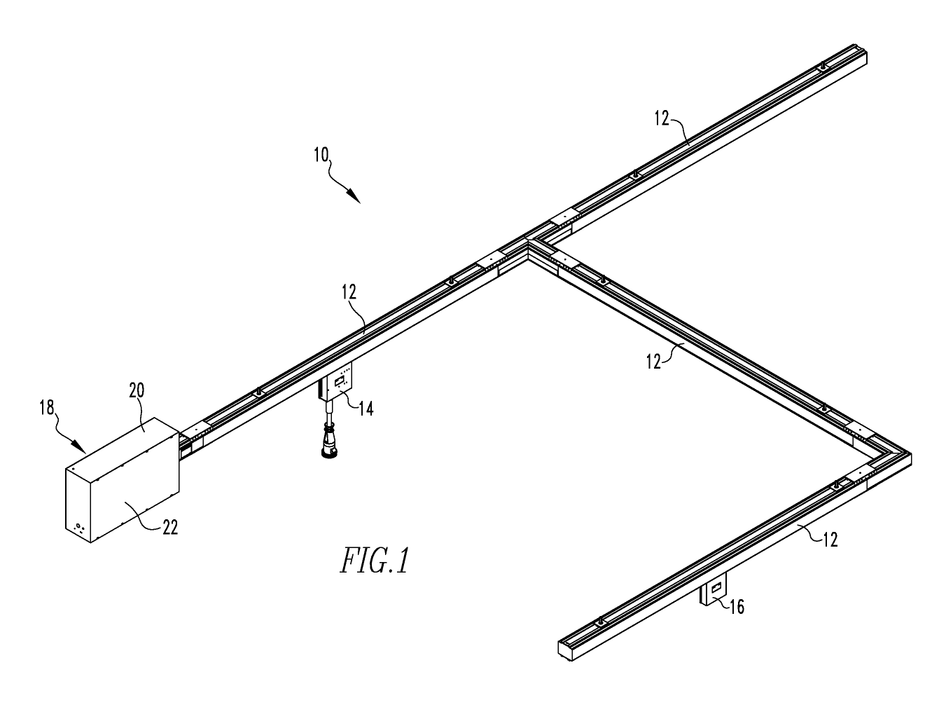

A continuous busway system 10 in accordance with an example embodiment of the present invention is shown in FIG. 1. The busway system 10 includes a number of linear busway sections 12 which each include a housing (not numbered) having a number of conductive busbars (not shown) disposed therein. A continuous access slot (not shown) which allows tap boxes (such as the example plug-in units 14 and 16 shown) to be placed at any convenient location along the system 10 is provided in the housing of each of the section 12. The power connections to the busway sections 12 are made at a power feed assembly 18, which is shown as an ‘end feed’ unit in the illustrated embodiment of FIG. 1. Although shown as an ‘end feed’ unit, it is to be appreciated that that the concepts described herein could also be readily applied to other arrangements (e.g., without limitation, ‘center’ feed assemblies). Power feed assembly 18 includes a housing 20 defined in part by a number of access panels 22 (only one is visible in FIG. 1) which may be readily removed through the use of suitable fasteners to provide access to the interior of the housing 20.

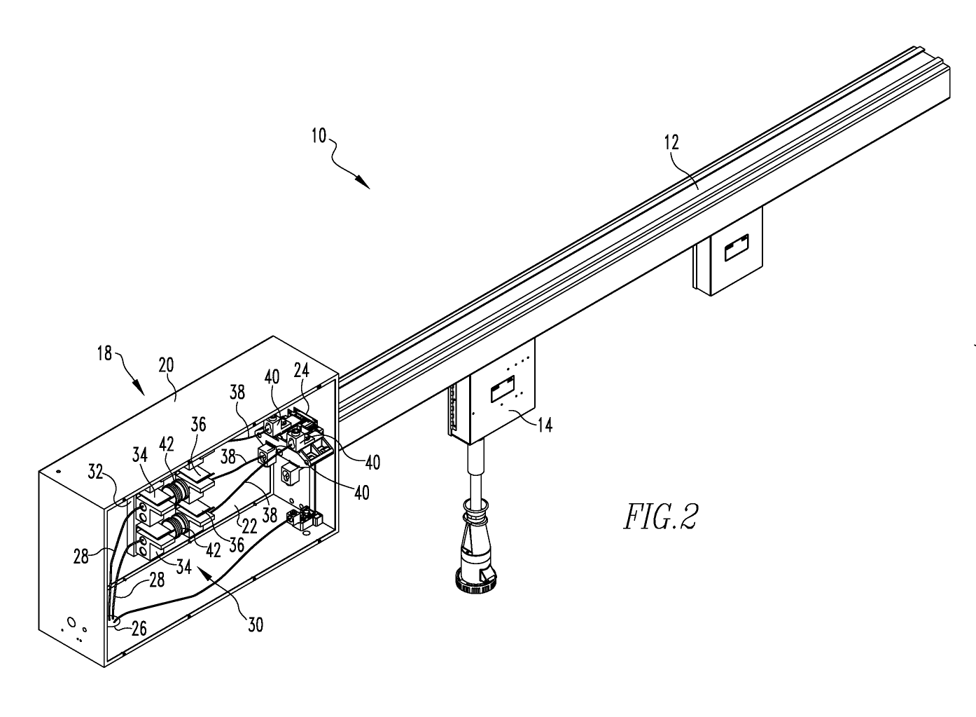

FIG. 2 illustrates a portion of the busway system 10 including the power feed assembly 18 shown with one of the access panels 22 removed to show internal components of the power feed assembly 18 in accordance with an example embodiment of the present invention. Continuing to refer to FIG. 2, housing 20 includes a first opening 24 and a second opening 26 defined therein. First opening 24 is structured to have a section 12 of electrical busway coupled thereto via any suitable means and second opening 26 is structured to receive a number (two are shown) of line voltage conductors 28 therethrough.

Power feed assembly 18 further includes a fuse support 30 which may be coupled to any suitable portion of housing 20. Fuse support 30 includes a support member 32 formed from a non-conductive material (e.g., without limitation, polycarbonate or other suitable non-conductive material), a number of first conductive members 34 coupled to the support member 32 and a number of second conductive members 36 coupled to the support member 32. Each of the first conductive members 34 is structured to receive and couple a respective one of the line voltage conductors 28 to the support member 32. Each of the second conductive members 36 is structured to be in electrical communication (e.g., without limitation, via wire conductors 38 and lugs 40) with a respective busbar of the section 12 of busway coupled to the housing 20. Support member 32 is structured to have a number of fuses 42 coupled thereto via any suitable means such that each fuse 42 forms all or at least a portion of an electrical pathway (not numbered) between a respective one of the number of first conductive members 34 and a respective one of the number of second conductive members 36.

Although illustrated using bottom fed line voltage power connections 28, it is to be appreciated that a similar arrangement may be made with end or top line voltage power feeds. In contrast to the arrangement of the present invention illustrated in FIG. 2, conventional busway systems do not employ fuseblocks mounted within a power feed assembly but instead utilize fuseblocks mounted within a switchgear cabinet, with output cables then routed via conduit from the switchgear cabinet to a direct wired (unfused) busway power feed assembly located elsewhere in the facility.

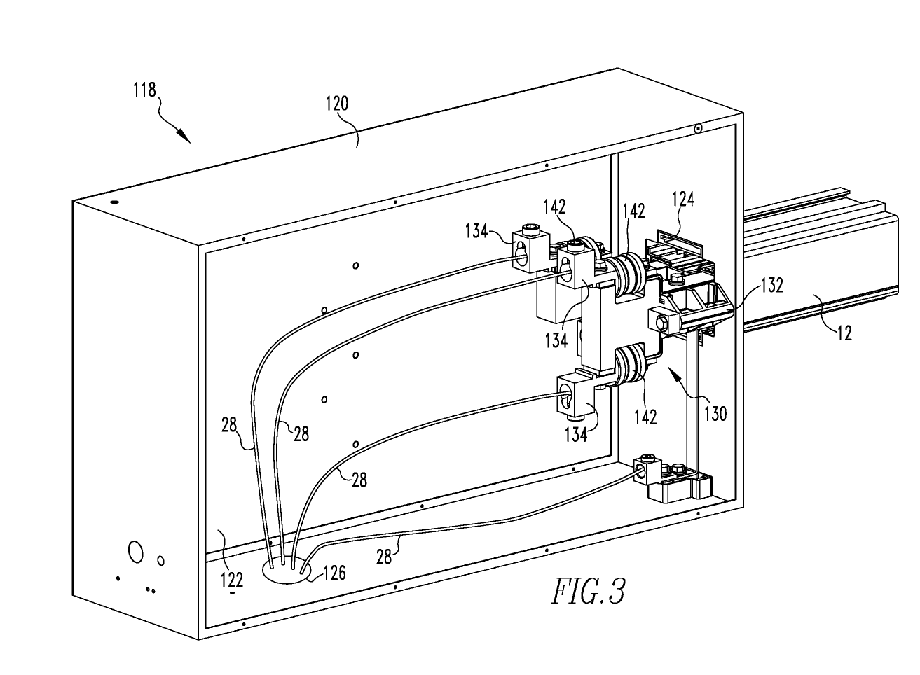

FIGS. 3-7 illustrate a power feed assembly 118 and fuse support 130 thereof in accordance with another example embodiment of the present invention. Similar to power feed assembly 18 previously discussed, power feed assembly 118 includes a housing 120 defined in part by a number of access panels 122 (in FIG. 3, one is shown installed and the other has been removed to show internal elements) which may be readily removed through the use of suitable fasteners to provide access to the interior of the housing 120. Housing 120 includes a first opening 124 and a second opening 126 defined therein, first opening 124 being structured to have a section 12 of electrical busway coupled thereto via any suitable means and second opening 126 being structured to receive a number (three are shown in FIG. 3) of line voltage conductors 28 therethrough.

Power feed assembly 118 further includes a fuse support 130, however, unlike the embodiment described in conjunction with FIG. 2 wherein fuse support 30 was provided somewhat remote from section 12, fuse support 130 is provided in much closer proximity to section 12 of electrical busway, thus allowing for a more compact design for assembly 118 while still providing all of the benefits of the arrangement previously discussed.

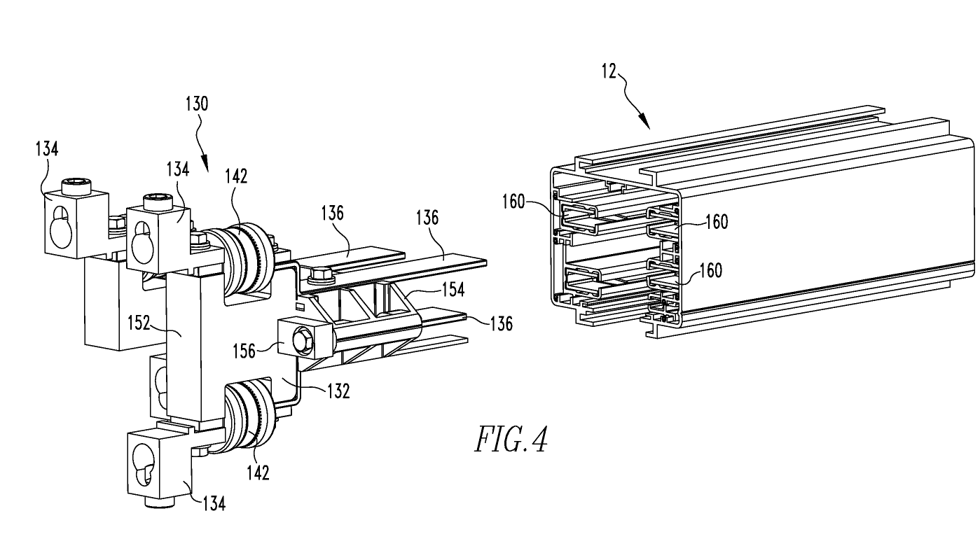

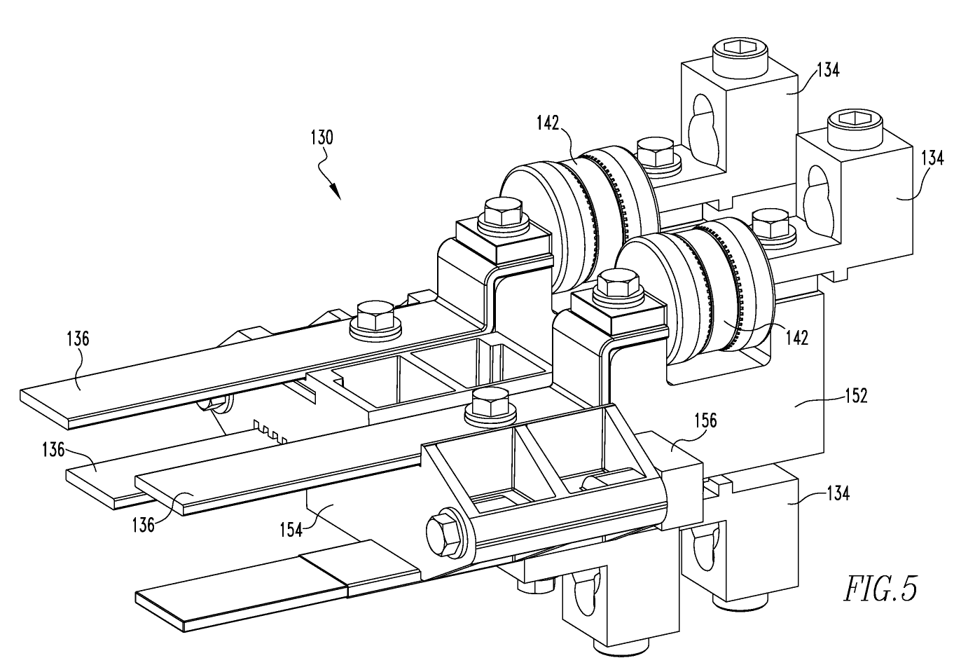

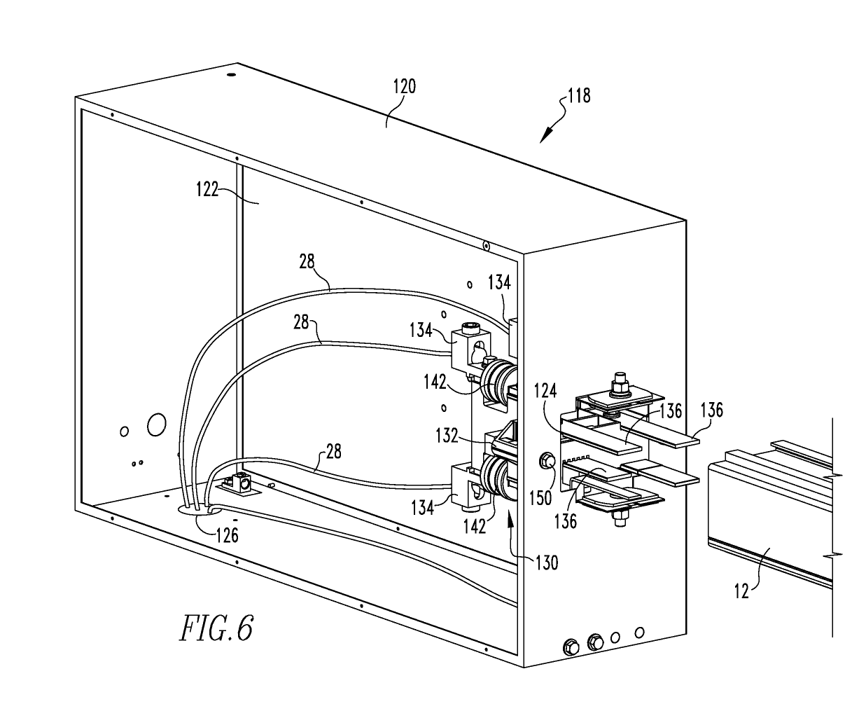

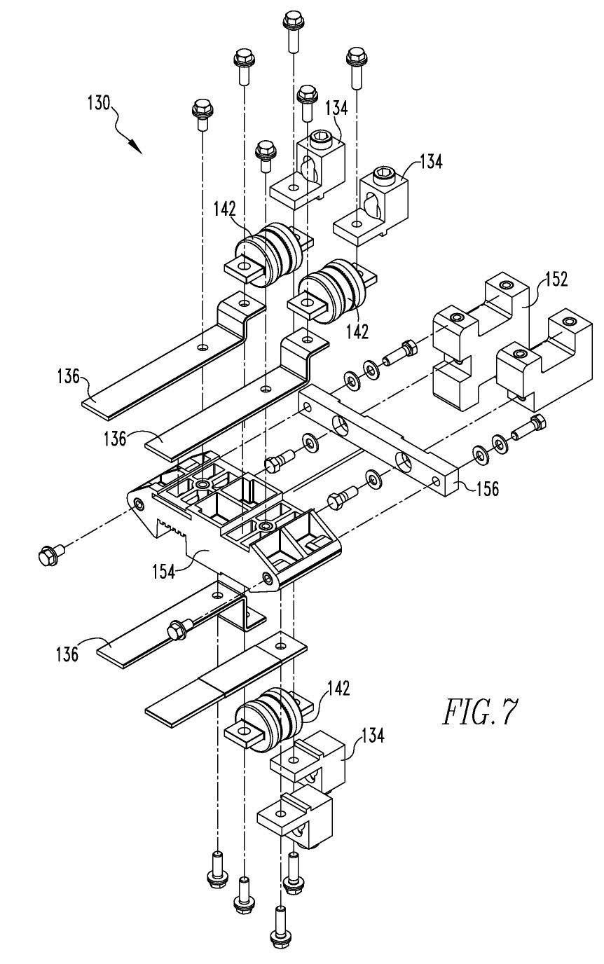

Referring to FIGS. 4 and 5, fuse support 130 includes a support member 132 formed from a non-conductive material (e.g., without limitation, polycarbonate or other suitable non-conductive material), a number of first conductive members 134 (e.g., without limitation, electrical lugs) coupled to the support member 132 generally about a first end (not numbered) thereof and a number of second conductive members in the form of stabs 136 coupled to, and extending from, an opposite second end (not numbered) of the support member 132. Support member 132 may be formed as a single member or alternatively may be formed from multiple components (e.g., without limitation, such as shown in the illustrated embodiment). Referring to the exploded view of FIG. 7, support member 132 includes a first support member 152 formed from a nonconductive material and a second support member 154 formed from a nonconductive material coupled to the first support member 152 either directly or indirectly (e.g., via member 156 of FIG. 7). As shown in FIGS. 3 and 6, support member 132 is structured to be coupled to housing 120 at or about first opening 124 via a number of suitable fasteners 150 (e.g., without limitation, bolts) in a manner such that the stab members 136 protrude from housing 120.

As shown in FIGS. 3 and 6, each of the first conductive members 134 is structured to receive and couple a respective one of the line voltage conductors 28 to the support member 132. As shown in the exploded view of FIG. 4, each of the stab members 136 (which protrude from housing 120) directly engage a respective busbar 160 of the section 12 of electrical busway which is coupled to the housing 120. A number of fuses 142 are coupled to support member 132 in a manner such that each fuse 142 forms a portion of an electrical pathway (not numbered) between a respective one of the first conductive members 134 and a respective one of the stab members 136, thus providing a fused electrical connection directly at the section 12 of electrical busway between each line voltage conductor 28 and each busbar 160 of the section 12.

Although illustrated as an ‘end’ feed assembly, it is to be appreciated that the fuse support assembly illustrated in FIGS. 3-7 may readily employed in other feed arrangements without varying from the scope of the present invention.

It is to be appreciated that the sections 12 of electrical busway illustrated herein are provided for exemplary purposes only and are not intended to be limiting upon the scope of the present invention.

While specific embodiments of the present invention have been described in detail, it will be appreciated by those skilled in the art that various modifications and alternatives to those details could be developed in light of the overall teachings of the disclosure. For example, without limitation, different fuse elements and/or mechanisms for coupling them with support members as described herein may be employed without varying from the scope of the present invention. Accordingly, the particular arrangements disclosed herein are meant to be illustrative only and not limiting as to scope of the present invention which is to be given the full breadth of the claims appended and any and all equivalents thereof.

What is claimed is:

1. A fuse support comprising:
a support member formed from a non-conductive material;
a number of fasteners coupled to the support member, each fastener formed from a conductive material and structured to couple a line voltage conductor to the support member; and
a number of stab members coupled to and extending from the support member, each stab member formed from a conductive material and structured to engage a respective busbar of a section of busway,
wherein the support member is structured to have a number of fuses coupled thereto such that each fuse forms a portion of an electrical pathway between a respective one of the number of fasteners and a respective one of the number of stab members.

2. The fuse support of claim 1 wherein the number of fasteners are disposed generally about a first end of the support member and wherein the number of stab members extend from a second end of the support member generally opposite the first end.

3. The fuse support of claim 1 wherein the support member is structured to be coupled to the housing of a power feed assembly and wherein the number of stab members are structured to protrude from the housing when the support member is coupled to thereto.

4. The fuse support of claim 1 wherein the support member comprises a first support member formed from a nonconductive material and a second support member formed from a nonconductive material coupled to the first support member; wherein the number of fasteners are coupled to the first support member; and wherein the number of stab members are coupled to the second support member.

5. A power feed assembly for use in an electrical busway system, the power feed assembly comprising:
a housing defined in-part by a number of removable access panels coupled thereto, the housing comprising:
a first opening defined therein, the first opening being structured to have a section of electrical busway coupled thereto; and
a second opening defined therein, the second opening being structured to receive a number of line voltage conductors therethrough; and
a fuse support coupled to the housing, the fuse support comprising:
a support member formed from a non-conductive material;
a number of first conductive members coupled to the support member, each first conductive member being structured to couple a respective one of the line voltage conductors to the support member; and
a number of second conductive members, each second conductive member being structured to be in electrical communication with a respective busbar of a section of busway coupled to the housing,
wherein the support member is structured to have a number of fuses coupled thereto such that each fuse forms a portion of an electrical pathway between a respective one of the number of first conductive members and a respective one of the number of second conductive members.

6. The power feed assembly of claim 5, wherein the number of second conductive members comprise a number of stab members coupled to and extending from the support member; wherein the support member is coupled to the housing about the first opening; wherein the number of stab members protrude from the housing through the first opening; and wherein each stab member of the number of stab members is structured to directly engage a respective busbar of a section of busway coupled to the housing.

7. The power feed assembly of claim 6 wherein the number of first conductive members are disposed generally about a first end of the support member and wherein the number of stab members extend from a second end of the support member generally opposite the first end.

8. The power feed assembly of claim 5 wherein the support member comprises a first support member formed from a non-conductive material and a second support member formed from a non-conductive material coupled to the first support member; wherein the number of first conductive members are coupled to the first support member; and wherein the number of second conductive members are coupled to the second support member.

9. An electrical busway power distribution system comprising:
a section of electrical busway including a housing having a number of electrical busbars disposed therein;
a power feed assembly comprising:
a housing defined in-part by a number of removable access panels coupled thereto, the housing comprising:
a first opening defined therein, the first opening having a portion of the section of electrical busway coupled thereabout; and
a second opening defined therein, the second opening being structured to receive a number of line voltage conductors therethrough; and
a fuse support coupled to the housing, the fuse support comprising:
a support member formed from a non-conductive material;
a number of first conductive members coupled to the support member, each first conductive member being structured to couple a respective one of the line voltage conductors to the support member; and
a number of second conductive members coupled to the support member and in electrical communication with a respective electrical busbar of the section of electrical busway,
wherein the support member is structured to have a number of fuses coupled thereto such that each fuse forms a portion of an electrical pathway between a respective one of the number of first conductive members and a respective one of the number of second conductive members.

10. The electrical busway power distribution system of claim 9, wherein the number of second conductive members comprise a number of stab members coupled to and extending from the support member; wherein the support member is coupled to the housing at or about the first opening; wherein the number of stab members protrude from the housing through the first opening; and wherein each stab member of the number of stab members directly engages a respective one of the electrical busbars of the section of electrical busway.

11. The electrical busway power distribution system of claim 10 wherein the number of first conductive members are disposed generally about a first end of the support member and wherein the number of stab members extend from a second end of the support member generally opposite the first end.

12. The electrical busway power distribution system of claim 9 wherein the support member comprises a first support member formed from a non-conductive material and a second support member formed from a non-conductive material coupled to the first support member; wherein the number of first conductive members are coupled to the first support member; and wherein the number of second conductive members are coupled to the second support member.
